(19) United States
(12) Patent Application Publication
(10) Pub. No.: US 2021/0404749 A1
(43) Pub. Date: Dec. 30, 2021

(54) MULTILAYER SHEETS FOR HEAT EXCHANGERS

(71) Applicant: Treau, Inc., San Francisco, CA (US)

(72) Inventors: Jason Stein Wexler, San Francisco, CA (US); Bataung Mohapi, Berkeley, CA (US)

(21) Appl. No.: 17/364,176

(22) Filed: Jun. 30, 2021

Related U.S. Application Data
(60) Provisional application No. 63/046,421, filed on Jun. 30, 2020.

(51) Int. Cl. F28F 3/08

(52) U.S. Cl. CPC F28F 3/08

(57) ABSTRACT

An air thermal conditioning system for at least one of heating air and cooling air. The air thermal conditioning system comprises one or more heat exchanger units that include at least one fluid chamber defined by first and second multilayer sheets. The first and second multilayer sheets each comprise an inner layer defining the at least one fluid chamber; a middle layer; and an outer layer that defines external opposing faces of the heat exchanger unit, the middle layer disposed between the inner layer and outer layer.

### CROSS-REFERENCE TO RELATED APPLICATIONS

This application is a non-provisional of and claims priority to U.S. Patent Application No. 63/046,421, filed Jun. 30, 2020, entitled “MULTILAYER SHEETS FOR HEAT EXCHANGERS” having attorney docket number 0111058-005PRO. This application is hereby incorporated herein by reference in its entirety and for all purposes.

This application is related to U.S. patent application Ser. No. 16/774,970, filed Jan. 28, 2020 Entitled “FILM HEAT EXCHANGER COUPLING SYSTEM AND METHOD,” having attorney docket number 0111058-002US1 and is related to U.S. patent application Ser. No. 16/774,946, filed Jan. 28, 2020 entitled “POLYMER FILM HEAT EXCHANGER SEALING SYSTEM AND METHOD,” having attorney docket number 0111058-002US0. These applications are hereby incorporated herein by reference in their entirety and for all purposes.

This application is also related to U.S. patent application Ser. No. 12/724,036, filed Mar. 15, 2010, entitled “MODULAR AIR CONDITIONING SYSTEM,” with attorney docket number 0111058-004US0. This application is hereby incorporated herein by reference in its entirety and for all purposes.

This application is related to U.S. patent application Ser. No. 15/161,029 entitled “Membrane heat exchanger system and method” filed May 20, 2016, having attorney docket number 0105198-007US0 and is related to U.S. application Ser. No. 16/156,364 filed Oct. 10, 2018, having attorney docket number 0105198-025US0 entitled “Conformable Heat Exchanger System And Method,” which applications, along with continuations thereof, are hereby incorporated herein by reference in their entirety and for all purposes.

### BACKGROUND

Conventional heat exchangers can be made using high-conductivity metals such as copper and aluminum which separate the heat exchange fluids using tubes or sheets that are brazed or welded together to form a sealed system. The manifolding of metal tube or microchannel heat exchangers can have significant effect on the manufacturing cost and the ultimate heat transfer performance of the heat exchanger by affecting parameters like pressure drop and flow distribution.

For example, in the manufacturing of finned-tube heat exchangers commonly employed in liquid-to-air heat transfer, individual tubes can be inserted between fins and then expanded in order to make good thermal contact, and then “u”-fittings are brazed on in a specified pattern in order to form the liquid flow path. Because tubes are connected in series, it can be a difficult task to determine the optimal refrigerant flow path for best heat transfer in a particular heat exchanger. In addition, connecting these tubes in series can result in a higher pressure drop than is necessary due to the long flow path and requires greater pumping power than a parallel flow configuration.

Conventional heat exchangers can be made from the assembly of one or more rigid tubes or channels, where one fluid flows over, around, or outside of the tubes/channels and another fluid flows inside. The purpose of such tubes/channels is to facilitate heat transfer from one fluid to the other. Common types of heat exchangers include shell-and-tube, plate, tube-fin, microchannel-fin, and pillow plate heat exchangers. In nearly all of these common types, the physical shape and configuration is partially or completely determined by the construction method of the heat exchanger. For example, cylinders are common for shell-and-tube heat exchangers and boxes are common for most other types. Furthermore, the shape and size of the heat exchanger are fixed after manufacture, and cannot change during installation or operation.

Conventional fin-and-tube heat exchangers, (e.g., car radiators), are highly constrained in geometric layout and do not fit well into confined volumes of arbitrary shape. The result of this is that systems which use conventional heat exchangers require such heat exchangers to be specifically designed to accommodate physical shape requirements of the system. If heat exchangers were able to change in size or adapt to different sizes and shapes, the configurations of systems that use heat exchangers would have more design flexibility and, consequently, more opportunities for performance improvement. Accordingly, there is a need for flexible heat exchanger systems that provide for improved design flexibility and opportunities for performance improvement.

In various embodiments, the temperature difference ΔT across a heat exchanger directly equates to a loss in exergy. After accounting for the ΔT across a heat exchanger, the Carnot coefficients of performance for heat pumps in cooling and heating systems become:

$${COP}_{cooling} = \frac{{T}_{c} - Δ T}{( {T}_{h} + Δ T ) - ( {T}_{c} - Δ T )} {COP}_{healing} = \frac{{T}_{h} + Δ T}{( {T}_{h} + Δ T ) - ( {T}_{c} - Δ T )}$$

where Tₕ and T_{c} are hot and cold temperatures at either end of the system and ΔT is the additional temperature difference required to transfer heat to the air through a heat exchanger. However, ΔT is constrained by the need to exchange heat at a sufficient rate; this heat flux from one fluid, through a wall, into a second fluid is a function of the combined heat transfer due to convection in both fluids and conduction and is given by

$$Q = {h}_{1} A Δ {T}_{1} Q = {h}_{2} A Δ {T}_{2} Q = \frac{kA Δ {T}_{3}}{t} ⟹ Q = \frac{A Δ T}{\frac{1}{{h}_{1}} + \frac{1}{{h}_{2}} + \frac{t}{k}}$$

where A is the surface area of the heat exchanger, t is the wall thickness, k is the thermal conductivity of the material, h₁ and h₂ are the heat transfer coefficients of either fluid and Q is the heat transfer.

Power plants and other implementations are similarly limited by heat exchanger ΔT via the Carnot efficiency

$$η = \frac{{T}_{h} - ( {T}_{c} + Δ T )}{{T}_{h}}$$

In various embodiments, laminar flow heat transfer and flow losses are approximated by

$$Q = \frac{NukA Δ T}{d} {P}_{fan} = \frac{8 A μ {v}^{2}}{d}$$

where Nu is the Nusselt number, d is the effective tube diameter, P_{fan} is the required fan power, μ is the viscosity, and v is the fluid velocity.

The heat transfer rate in a heat exchanger is directly proportional to the surface area in the heat exchanger. Increasing the surface area can increase the overall heat transfer, thereby increasing performance. This can be impractical with conventional heavy metallic heat exchangers.

Metallic fin-and-tube heat exchangers, similar to automotive radiators, are the current standard for conventional heat exchangers. Most metals have high densities and become fragile and corrosion sensitive at thin film thicknesses. Thus, metallic heat exchangers are heavier and more expensive than otherwise required for a given operating pressure or desired heat transfer rate and typically rely on high-power fans which reduce efficiency.

In view of the foregoing, a need exists for improved heat exchangers, and an improved system and method for manufacturing the same, in an effort to overcome the aforementioned obstacles and deficiencies of conventional heat exchanger systems and methods of manufacturing the same.

### BRIEF DESCRIPTION OF THE DRAWINGS

FIG. 1 is a top view of a heat exchanger unit in a flat configuration in accordance with one embodiment.

FIG. 2 illustrates a plurality of membrane heat exchanger units configured together into a cross-flow heat exchanger array, wherein the plurality of membrane heat exchanger units are stacked in parallel with a space separating each of the membrane heat exchanger units.

FIG. 3 illustrates a heat exchanger array with fluid being introduced into the cavity of the heat exchanger with the fluid entering the cavity at a first port and flowing through a plurality of channels of a set of heat exchanger units.

FIG. 4 is a perspective view of a heat exchanger array of another embodiment.

FIG. 5 is a front view of a heat exchanger array of a further embodiment.

FIG. 6a is a cross-sectional side view of a portion of a heat exchanger unit having two multilayer sheets that define a chamber in accordance with one embodiment.

FIG. 6b is a cross-sectional side view of a portion of a heat exchanger unit having two multilayer sheets that define a chamber in accordance with another embodiment.

FIG. 7a illustrates a pair of sheets.

FIG. 7b illustrates a plurality of welded seams generated between the pair of sheets of FIG. 7a.

FIG. 7c illustrates a first plurality of elongated welds generated in the coupled sheets of FIG. 7b.

FIG. 7d illustrates a second plurality of elongated welds generated in the coupled sheets of FIG. 7c.

FIG. 7e illustrates cutting the coupled sheets of FIG. 7d to generate a plurality of separate units.

FIG. 7f illustrates arranging the separate units of FIG. 7e.

FIG. 8a illustrates an example geometry of a burst test sample.

FIG. 8b illustrates a schematic of a setup of an example burst test.

FIG. 9a illustrates a modular climate control unit in accordance with one example embodiment.

FIG. 9b illustrates a circulation hose in accordance with one example embodiment.

FIG. 10 illustrates an external unit comprising a heat pump/air conditioning cycle in accordance with one example embodiment.

FIG. 11 illustrates circulating fluid directed to reduce the overall temperature of a fluid storage tank within the interior unit in accordance with one example embodiment.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

Heat exchangers made from thin-walled polymer film materials can have a wide range of benefits over metal heat exchangers by having similar heat transfer coefficients and using a less expensive material while also corrosion resistance. An additional advantage of using polymer films in some examples can be that unique geometries can be made from these materials which could not be easily manufactured using metals.

As discussed herein, various embodiments can include sheets or films for heat exchangers that comprise an inner layer comprising polypropylene or polyethylene, with the inner layer allowing cavities of a heat exchanger to be generated by one or more sheets being welded together. Various embodiments can include a middle layer comprising either aluminum foil or metallized aluminum or aluminum oxide or silicon oxide configured to prevent the permeation of fluid inside the cavities. Various embodiments can be characterized as multi-layer materials with an aluminum layer or as thin aluminum sandwiched between low melting point/high surface energy materials.

Embodiments can also include an outer layer comprising biaxially-oriented\polyethylene terephthalate (BOPET) or biaxially oriented polypropylene, with the outer layer configured to protect the middle layer from damage during construction or use. Some embodiments can comprise a layer of biaxially oriented nylon, which can provide for increased toughness and punctuation resistance. Various embodiments can comprise, consist essentially of, or consist of one or more of such layers. Heat exchanger units can be welded using ultrasound and/or heat, in a single or multi-step process.

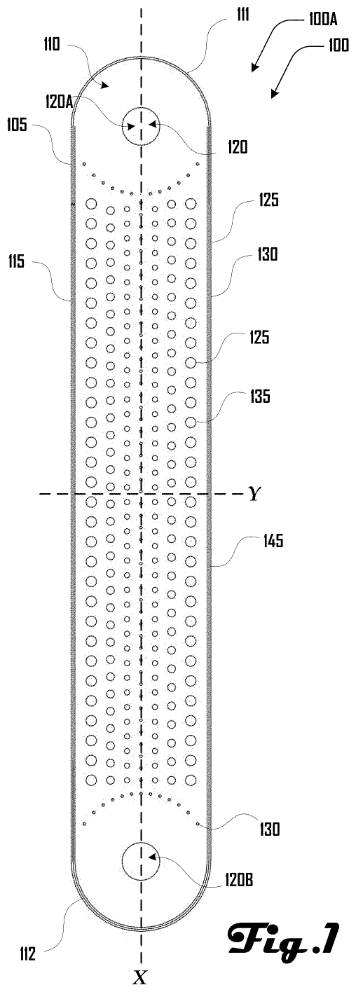

Turning to FIG. 1, a first example embodiment 100A of a membrane heat exchanger unit 100 is shown as comprising an elongated planar body 105 that includes a chamber 110 defined by a pair of coupled sheets 115, with the chamber 110 extending along the length of the body 105. The body 105 extends along an axis X, with the heat exchanger unit 100 of this example 100A having symmetry about axis X and about perpendicular axis Y.

The chamber 110 is further defined by a pair of ends 111, 112 that define ports 120 that can be respective openings to the chamber 110. As discussed herein, the ports 120 can be used to allow fluid to enter and/or exit the chamber. The pair of sheets 115 that define the chamber 110 can be coupled peripherally via seams 125 that define a peripheral edge 130 that forms the enclosed chamber 110. Additionally, the opposing sheets 115 can be further coupled via one or more seams 125 that define one or more internal couplings 135, which can be various suitable shapes.

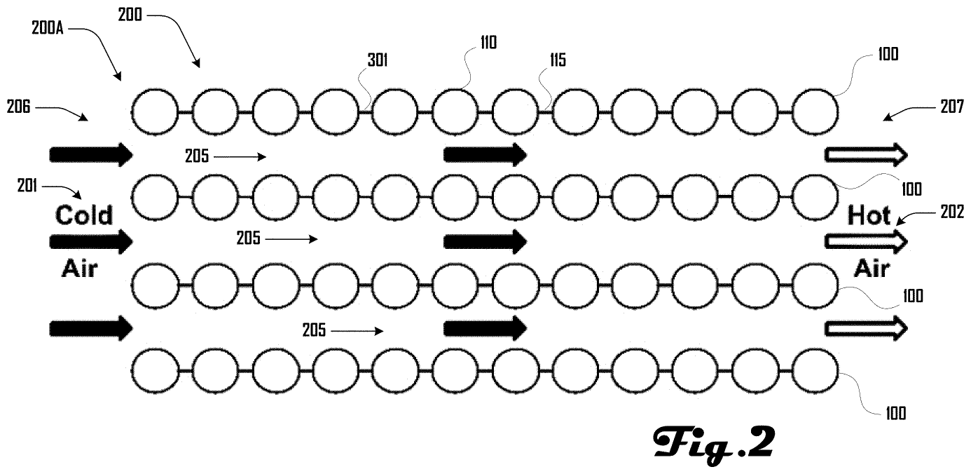

In various embodiments, ports 120 can be defined by and extend through both sheets 115. In other words, both sheets 115 of a pair of sheets 115 define ports 120, with an opening defined by the ports extending from a first external face of the first sheet 115 to a second opposing external face of a second sheet 115. Such a configuration can be desirable for manufacturing heat exchanger arrays 200 (see e.g., FIGS. 2-4) by coupling a plurality of heat exchanger units 100 together via respective adjacent ports 120 to generate a cavity connecting the plurality of heat exchanger units 100, which can generate one or more common fluid paths through which fluid can enter and/or exit the plurality of coupled heat exchanger units 100 that define a heat exchanger array 200. This is discussed in more detail herein.

Returning to FIG. 1, the internal couplings 135 can comprise circular seams 125 of various sizes that couple the sheets 115. The internal couplings 135 can be disposed in columns that extend parallel to axis X, with columns of internal couplings 135 becoming increasingly smaller from the peripheral edge 130 toward central axis X.

Additionally, a spine 145 can be disposed along the sides of the heat exchanger unit 100, which in some examples can be a portion of the chamber 110 defined by elongated tubes or ducts, and such spines 145 can create linear regions of limited contraction in at least one direction, which can be desirable for supporting the heat exchanger unit 100 and/or controlling the shape of the heat exchanger when inflated and/or deflated.

Although specific embodiments of membrane heat exchanger units 100 and chambers 110 are discussed above, further embodiments can have chambers 110 of any suitable size, shape and configuration, and the present examples should not be construed to be limiting on the wide variety of configurations of membrane heat exchanger units 100 that are within the scope and spirit of the present disclosure. Additionally, while various embodiments described herein illustrate membrane heat exchanger units 100 having a heat exchanger body 105 that defines a single chamber 110 with a pair of ends 111, 112 in further embodiments, a heat exchanger body 105 can define a plurality of chambers 110.

Accordingly, various embodiments of a membrane heat exchanger unit 100 can comprise a plurality of small and thin-walled chambers 110 instead of heavy, metal tubes with soldered-on fins as in conventional heat exchanger systems. Thus, various embodiments of a membrane heat exchanger can be configured to decrease ΔT while keeping Q constant by increasing the surface area A, which can be achieved (without increases to mass and cost) by a small thickness t.

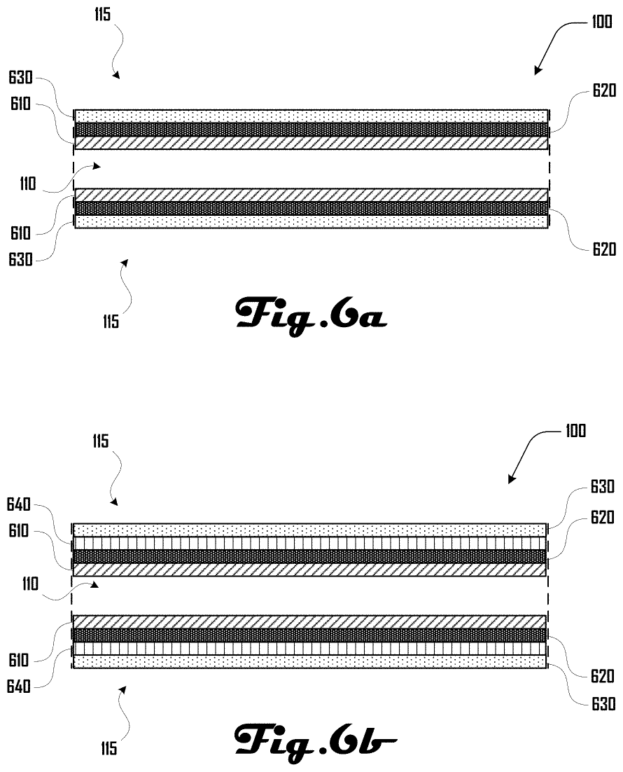

FIG. 6a is a cross-sectional side view of a portion of a heat exchanger unit 100 having two multilayer sheets 115 that define a chamber 110. As shown in the example of FIG. 6a the sheets 115 can comprise an inner layer 610 directly defining and facing the internal chamber 110, a middle layer 620, and an outer layer 630 that defines external opposing faces of the heat exchanger unit 100. The middle layer 620 can be disposed between the inner layer 610 and outer layer 630. In various embodiments, the layers 610, 620, 630 can be coupled together in various suitable ways (e.g., adhesive, sealant, welding, lamination, and the like) to define a unitary layered sheet 115 with cavities, gaps or un-joined portions between layers being absent.

In various embodiments, the inner layer 610 can be configured for allowing the chamber 110 of the heat exchanger unit 100 to be generated by the sheets 115 via the inner layers 610 of the respective opposing sheets 115 being coupled together, including by being welded together by various suitable methods including example methods discussed herein and in related patent application Ser. Nos. 16/774,970 and 16/774,946 cited above, which are incorporated herein by reference. For purposes of clarity, such couplings or welds are not shown in FIG. 6a.

The inner layer 610 can comprise, consist essentially of, or consist of various suitable materials including polypropylene, cast un-oriented polypropylene (CPP), polyethylene, polyethylene terephthalate (PET), fluoropolymers, polyimides, polyamides, and the like. Some preferred embodiments consist of or consist essentially of a polyolefin such as polypropylene or polyethylene.

In various embodiments, the inner layer 610 can comprise weldable polyolefins and the middle layer 620 can comprise a material with a higher melting point than the inner layer 610 such as polyethylene terephthalate, polyamide or aluminum (e.g., aluminum foil or metallized aluminum) and can be configured to prevent the permeation of fluid from inside a cavity 110 of a heat exchanger unit 100 to the outside of the heat exchanger unit 100. While some embodiments can include an aluminum middle layer 620, further embodiments can include a middle layer 620 of any suitable metal, alloy, or the like.

A sealant, adhesive, sealant layer or adhesive layer can bond the inner layer 610 with the higher-melting-point middle layer 620 in various examples. Accordingly, in various embodiments, a pair of multilayer sheets 115 can be coupled together to form a heat exchanger unit 100 by exposing adjoining inner layers 610 to sufficient heat to melt and join the inner layers 610, but at a temperature and for a time that does not melt the higher-melting-point middle layer 620.

In some embodiments, a metallic middle layer 620 of multilayer sheets 115 can act as a welding element such that additional welding elements need not be present aside from the metallic middle layer 620. In other words, in some embodiments, additional metallic welding elements can be absent or replaced by a metallic middle layer 620 of multilayer sheets 115, which can be used to weld sheets 115 and/or heat exchanger units 100 together.

For example, in one embodiment, an aluminum foil middle layer 620 in a laminate sheet 115 can be induction-heated with a solenoid coil (e.g., similar to implant induction welding as discussed herein). A non-stick spacer or silicone film can be applied between the walls of each individual heat exchanger unit 100 or sheets 115 to avoid welding shut the heat exchanger units 100 as discussed herein. Since a far-field magnetic field strength decreases with increasing distance from the field source, the induction coil setup can be designed such that only specific areas of the middle layer 620 of one or more sheets 115 close to the coil where welding is desired are heated. The structure of a multilayer sheet 115 can also be optimized to melt the exterior walls of the heat exchanger units 100 without melting or burning the internal layers.

Though heat sealing offers a number of advantages in terms of performance, it can come with significant challenges related to manufacturing in some embodiments. Therefore, it may be desirable in some examples to manifold the heat exchanger units 100 together using techniques that do not require heat. For example, the connections between adjacent heat exchanger units 100 in a heat exchanger array 200 (see FIG. 2) can be made using an adhesive, double-sided tape, hot-melt adhesive, sealant, glue or the like. In some examples, such a sealant can comprise silicone, polyurethane, or the like. In some embodiments, connections can be non-permanent, with a seal created by applying normal force to a flexible gasket material.

Returning to the example of FIG. 6a, in various embodiments the outer layer 630 can be configured to protect the middle layer 620 from damage during construction of heat exchanger units 100 and/or during use of constructed heat exchanger units 100. Additionally, where the outer layer 630 is used to couple adjacent sheets 115 (e.g., coupling a pair of heat exchanger units 100 as discussed herein), having an outer protective layer that makes it easy to couple heat exchanger units 100 or sheets 115 together (e.g., via welding or other coupling method) can be desirable. In some embodiments, the outer layer 630 can comprise biaxially-oriented polyethylene terephthalate (BOPET) or biaxially oriented polypropylene (e.g., a biaxially oriented film being a film stretched in both machine and transverse directions, producing molecular chain orientation in two directions).

Some embodiments can comprise a layer of biaxially oriented nylon, which can provide for increased toughness, puncture-resistance, and the like. For example, FIG. 6b illustrates another embodiment where sheets 115 include a fourth layer 640 between the outer layer 630 and the middle layer 620. Such a fourth layer 640 can comprise, consist essentially of or consist of biaxially oriented nylon (BON) in some examples. In further embodiments, such a fourth layer 640 can be disposed between the middle layer 620 and inner layer 610 or can define a layer on an outer face or internal face of sheets 115 (e.g., outside of a BOPET layer).

While a broad variety of configurations of multilayer sheets 115 are within the scope and spirit of the present disclosure (e.g., in terms of number of layers, composition of layers, arrangement of layers, thickness of layers, and the like), certain applications of sheets 115 as heat exchangers can require sheets 115 having specific characteristics to provide for suitable manufacturing of heat exchanger units 100 and desirable operation of such heat exchanger units 100 in specific products and within specific operating parameters such as pressure, temperature and desired lifetime of heat exchanger units 100 within products such as air conditioners. Accordingly, various embodiments can require specific novel sheets 115 or heat exchanger units 100 that would not be an obvious design choice or result of routine optimization.

For example, in some embodiments, heat exchanger units 100 can be manufactured for use in heat exchange in portable residential or commercial air-conditioning units and sheets 115 used to manufacture such heat exchanger units 100 and the configuration of such heat exchanger units 100 can be specifically designed for desirable operation in such portable residential or commercial air-conditioning units. For example, heat exchanger units 100 can be configured for heat exchange within a typical or maximum range of temperatures experienced within residential settings such as −88 to 58° C., −60 to 50° C., −40 to 45° C., 0 to 58° C., 5 to 50° C., 10 to 45° C. or the like. In various embodiments, heat exchanger units 100 can be configured to have sufficient strength to operate at pressures up to 100 psi, 80 psi, 70 psi, 60 psi, 55 psi, 50 psi, 45 psi, 40 psi, 30 psi, 25 psi, 20 psi, 15 psi, 10 psi or the like, without bursting. In some examples, heat exchanger units can be configured to operate within a heat exchanger system at an operating pressure of equal to or less than 1 psi, 2 psi, 3 psi, 4 psi, 5 psi, 6 psi, 7 psi, 8 psi, 9 psi, 10 psi, or the like.

Additionally, it can be desirable to have sheets 115 that are as thin as possible to provide for maximum heat exchange and minimal cost, while also having low permeability to prevent an undesirable amount of fluid from being lost from a heat exchanger system over a desired product lifetime while also having suitable strength. For example, a heat exchanger system can comprise a reservoir of fluid that passes through one or more heat exchanger units 100 for heat exchange and it can be desirable for such a heat exchanger system to operate for a product lifetime without adding additional fluid to the fluid reservoir during the product lifetime. Accordingly, various embodiments can employ sheets 115 that are as thin as possible while not exceeding a maximum fluid transmission rate and also having a configuration that provides for heat exchanger units 100 to be manufactured having suitable strength to operate within operational pressure and temperature ranges.

For example, some embodiments can be configured for suitable operation during a product lifetime of 30 years, 20 years, 10 years, 5 years, 1 year, 6 months, and the like. In other words, a heat exchanger system can be configured for suitable operation for such a product lifetime without adding additional fluid to the fluid reservoir during the product lifetime.

Accordingly, some embodiments can comprise sheets 115, heat exchanger units 100 and/or a heat exchanger system that do not exceed a water vapor transmission rate (WVTR) of 10.0 g/(m² day), 1.0 g/(m² day), 0.1 g/(m² day), 0.01 g/(m² day), 0.005 g/(m² day), 0.001 g/(m² day), and the like.

Additionally, various embodiments can comprise heat exchanger units 100 defined by sheets 115 having a thickness within the range of 110-80 μm, or less than 200 μm, 150 μm, 125 μm, 100 μm, 75 μm, 50 μm, and the like. Layers of multilayer sheets 115 can be sized accordingly. For example, referring to FIGS. 6a and 6b in some embodiments, the inner layer 610 can be within a range of 40-90 μm, 50-90 μm, 60-90 μm, 70-90 μm, or less than or equal to 200 μm, 150 μm, 100 μm, 90 μm 80 μm, 75 μm, 70 μm, 65 μm, 60 μm, and the like. The middle layer 620 can have a thickness in the range of 10-8 μm or less than or equal to 30 μm, 20 μm, 15 μm, 10 μm, 9 μm, 5 μm, 1 μm, and the like. The outer layer 630 can have a thickness in the range of 13-11 μm, 10-20 μm, 12-18 μm, 14-16 μm or of less than or equal to 30 μm, 20 μm, 15 μm, 12 μm, 10 μm, 5 μm, and the like. The fourth layer 640 can have a thickness of less than or equal to 30 μm, 20 μm, 15 μm, 10 μm, 5 μm, and the like.

In one embodiment, polyethylene terephthalate (PET) films can be used, which in some implementations can have strengths as high as 200 MPa or more and thermal conductivities k in the 0.15-0.4 W/(mK) range, depending on additives. In some embodiments, sheets 115 or layers of a sheet can have a wall thickness of t=0.005 mm for a safe working stress of 30 MPa, tube diameter of 3 mm, and an operating pressure of 0.1 MPa (one atmosphere).

Low thermal conductivity materials can be used in some embodiments of heat exchanger units 100 by using a small thickness t. Based on hoop stress, the wall thickness required to hold a given pressure can be:

t=(Pressure·Tube radius)/Material stress

In various embodiments, chambers 110 of a small radius can generate a lighter and cheaper membrane heat exchanger unit 100 with better thermal conduction compared to conventional heat exchangers. For example, in various embodiments, four times as many chambers 110 of half the diameter doubles heat transfer for the same system mass/cost. Diameters of chambers 110 in the 1-10 mm range can be provided in accordance with some embodiments, with surface heat transfer coefficients h of around 50-100 W/(m²K) for air, and 5,000-10,000 W/(m²K) for flowing water and the condensing and evaporating of water.

Accordingly, embodiments that employ thin film polymer membranes can enable a substantial increase in surface area and heat exchanger performance. In other words, while polymers can have lower thermal conductivities k than metal, their thickness can be made small enough that t/k is small relative to 1/h₁ and 1/h₂ (see e.g., equation above in background that includes this expression).

As discussed herein, the heat transfer rate in a membrane heat exchanger unit 100 can be directly proportional to the surface area of the membrane heat exchanger unit 100. Accordingly, increasing the surface area can increase the overall heat transfer, thereby increasing performance. In various embodiments, computer-controlled manufacturing and polymer processing can enable the fabrication of a membrane heat exchanger unit 100 with thin walls and small masses, enabling increased surface areas while maintaining effectiveness of the membrane heat exchanger unit 100.

Accordingly, various embodiments discussed herein can use thin polymeric membranes for high surface-area membrane heat exchanger units 100, loaded within appropriate safety factors of the hoop-stress limit. In some embodiments, such a configuration can be enabled via patterned chambers 110 which can be generated via laser processing of pairs of sheets as discussed herein.

Using computer-controlled manufacturing tools, a number of fabrication options are available with thin polymeric membranes, which can be amenable to rapid prototyping as well as production. Additionally, the resilience of polymeric materials enables their use in various embodiments even when processed into very thin films—i.e., films thin enough to have negligible impact on the heat transfer rate across them.

For example, the heat transfer rate, Q, across a heat exchanger can be shown to be:

$$Q = {h}_{0} A Δ {T}_{LM} = \frac{A Δ {T}_{LM}}{\frac{1}{{h}_{w}} + \frac{1}{{h}_{a}} + \frac{t}{{k}_{m}}}$$

where h₀ is the overall heat transfer coefficient, A is the surface area of the heat exchanger, ΔT_{LM} is the logarithmic mean temperature difference across the heat exchanger, h_{w} is the heat transfer coefficient of the hot fluid that is being cooled, hₐ is the heat transfer coefficient of the cooling air, kₘ is the thermal conductivity of the membrane barrier wall between the two fluids, and t is the thickness of that barrier.

In some embodiments, increasing the overall heat transfer in a membrane heat exchanger unit 100 can be brought about by increasing the surface area of the membrane heat exchanger unit 100 and/or increasing the overall heat transfer coefficient. In an air-cooled membrane heat exchanger unit 100 the overall heat transfer coefficient can be dominated by the heat transfer coefficient of the air and there is little opportunity to increase the value of hₒ. However, the low density and thin walls of a membrane heat exchanger unit 100 can allow the surface area to be greatly increased which can improve performance.

Numerically, h_{w}>>hₐ, so for a membrane heat exchanger unit 100 with liquid on one side and air on the other, the 1/h_{w} term is very small compared to 1/hₐ. Metals typically have good thermal conductivity (around 10-400 W/mK), so in conventional heat exchangers the t/kₘ term can also be ignored compared to 1/hₐ. For many polymers, thermal conductivity may be smaller, (e.g., 0.1-0.4 W/mK) but by providing a barrier less than 1 mm thick, the t/kₘ term is still small compared to 1/hₐ, meaning that the polymer wall will not significantly impede heat transfer through the heat exchanger compared to a metal wall. Therefore, for a given desired rate of heat transfer, ΔT can be decreased in some embodiments, provided that the surface area can be proportionally increased.

While low thermal conductivity materials can be used in heat membrane heat exchanger units 100 if their thickness is very low, the wall thickness can be specified by the requirement to withstand the pressure forcing fluid through the chamber(s) 110 of the membrane heat exchanger unit 100. Based on hoop stress, the wall thickness required to hold a given pressure is:

$$t = \frac{pr}{σ}$$

where p is the pressure in the tube, r is the radius of the tube, and σ is the operating stress.

If we assume an example polymer film thickness of 0.1 mm (4 mil), high-density polyethylene (HDPE) with a maximum stress of 25 MPa and a working stress of 5 MPa, a 4 mm diameter tube can have a burst pressure of 1.25 MPa (180 psi), and a working pressure of 0.25 MPa (36 psi). Given a high-density polyethylene HDPE density of 970 kg/m³ this polymer film would have a mass of 0.097 kg/m². In further embodiments, higher strength polymers can be used and/or tube diameters can be reduced. This indicates that such embodiments of membrane heat exchanger units 100 can be mechanically resilient in addition to thermally responsive.

For the air side of the heat exchanger, the heat transfer rate, Q, can constrain the air mass flow rate, m,

Q=mcₚΔTₐ

where cₚ is the specific heat capacity of air, and ΔTₐ is the difference in temperature between the air entering and exiting the heat exchanger. Increasing mass flow across the heat exchanger surface can be accomplished through increased air velocity, but that brings with it increased power consumption, which may not be desirable. Assuming laminar flow, the power consumption of a fan can depend on the square of the linear velocity of the air,

P=(8Aμv²)/d

where v is the air velocity through the heat exchanger, d is the effective diameter of the air flow passage, μ is the viscosity of the fluid, and A is the surface area of the heat exchanger. Increasing the heat exchanger area can increase the flow resistance and thus the fan power for a given velocity; however, the air velocity can be reduced by increasing the cross-sectional area accepting the airflow. Since fan power can be proportional to the cross sectional area but also to the square of velocity, the trade-off of increased area for decreased velocity can result in a net reduction in necessary fan power.

Turning to FIG. 2, in various embodiments, a plurality of membrane heat exchanger units 100 can be grouped together into a cross-flow heat exchanger array 200, wherein the plurality of membrane heat exchanger units 100 are stacked in parallel with a space 205 separating each of the membrane heat exchanger units 100. The heat exchanger array 200 can be configured to cool fluid that is passing through the chambers 110 of the stacked heat exchanger units 100 by having cold air 201 enter a first end 206 of the spaces 205 separating the heat exchanger units 100 such that the cold air 201 passes over the chambers 110. The cold air 201 can receive heat energy from fluid flowing within the chambers 110 of the heat exchanger units 100, which heats the cold air 201 as the cold air 201 travels through the spaces 205 separating the heat exchanger units 100 such that hot air 202 leaves from a second end 207 of the heat exchanger array 200.

Although this example illustrates cold air 201 being used to cool fluid passing through the chambers 110 of the stacked heat exchanger units 100, in further embodiments, any suitable fluid can be used to heat or cool various suitable fluids passing through the chambers 110. In other words, a liquid or gas can flow through the chambers 110 of a heat exchanger array 200 and be heated or cooled in various embodiments. Additionally, a liquid or gas can flow through spaces 205 of a heat exchanger array 200 to heat or cool a fluid passing through the heat exchanger units 100 in accordance with further embodiments.

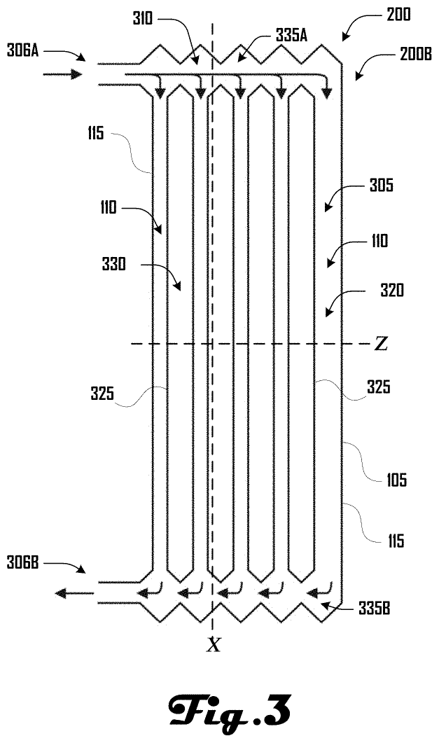

FIG. 3 illustrates an example embodiment 200B of a heat exchanger array 200 defined by a plurality of heat exchanger units 100, with fluid being introduced into a cavity 305 of the heat exchanger array 200B. This example illustrates fluid entering the cavity 305 at a first end port 306A and flowing through a plurality of channels 320 and leaving the cavity 305 via a second end port 306B as shown by the arrows in the figure. The manifold 310 can include the channels 320 and can be defined by a plurality of internal sidewalls 325 and/or one of the sheets 115 of heat exchanger units 100 that define the heat exchanger array 200.

The internal sidewalls 325 can define a plurality of internal passages 330. For example, the internal passages 330 can extend through the heat exchanger array 200B from opposing sides (e.g., along an axis Y that is perpendicular to axes X and Z). The internal passages 330 can be desirable for providing additional surface area for heat transfer between a first fluid within the cavity 305 of the heat exchanger array 200B and a second fluid surrounding the heat exchanger array 200B including the second fluid in contact with the sheets 115, the internal sidewalls 325 within the passages 330, and the like.

Additionally, a first and second conduit 335A, 335B can be disposed on opposing sides of the manifold 310 and can communicate with the end-ports 306A, 306B and the channels 320. For example, fluid can enter the first end-port 306A and flow into the first conduit 335A and into the channels 320 of the manifold 310. The fluid can flow through the manifold 320 and to the second conduit 335B, where the fluid can leave the cavity 305 of the heat exchanger array 200B via the second end-port 306B.

The heat exchanger array 200B can be configured to expand along axis Z when fluid fills the cavity 305 including the channels 320. However, while the heat exchanger array 200B can be extensible along axis Z, in various embodiments, the heat exchanger array 200B can be inextensible along other axes such as axis X and/or axis Y, which are perpendicular to each other and to axis Z. Also, various portions of the heat exchanger array 200B can be rigid or flexible. For example, in some embodiments, the sheets 115 and/or internal sidewalls 325 can be rigid.

In various embodiments, end fittings can be attached to a heat exchanger array 200, (e.g., in order to generate the first and second end ports 306A, 306B), which can provide for connecting the heat exchanger array 200 to tubing and interface the heat exchanger array with the rest of a larger system. Such end fittings can be barbed, threaded or the like, and can have a flange that interfaces with holes in a sheet 115 of a heat exchanger unit 100 at an end of the heat exchanger array 200. Such end fittings can be attached to one or more sheets 115 surrounding the membrane holes (e.g., ports 120), in some embodiments, via any suitable method including ultrasonic welding, impulse welding, sealing by compressing a flexible gasket, and the like.

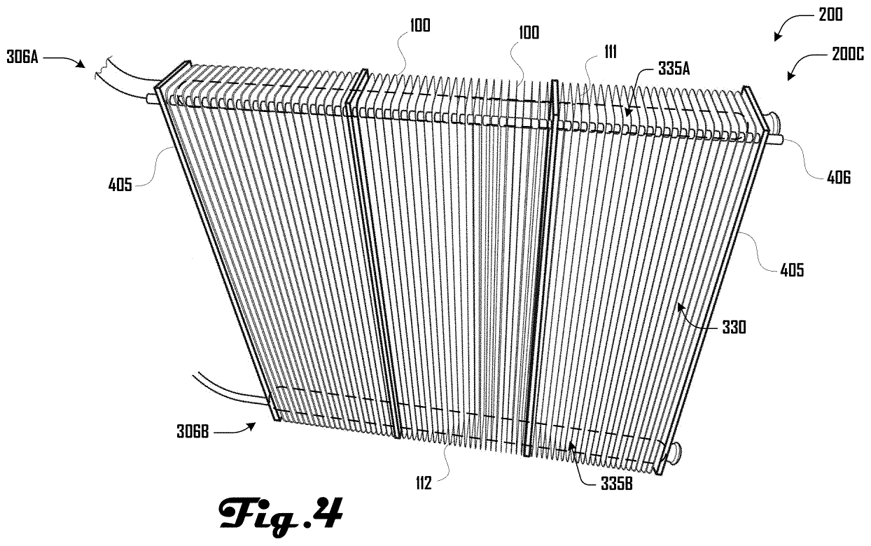

FIG. 4 illustrates a further embodiment 200C of a heat exchanger array 200 that comprises a plurality of stacked membrane heat exchanger units 100, which are supported within a housing 405 that can include at least one rail 406 upon which the plurality of heat exchanger units 100 hang generally in parallel. In various embodiments, the heat exchanger units 100 held in tension by a housing via respective opposing top and bottom ends of the respective heat exchanger units 100 (e.g., via one or more etched support rods to hold the positions of the heat exchanger units 100). Any suitable number of heat exchanger units 100 can be present within a heat exchanger array 200 including greater than or equal to 10, 15, 20, 25, 50, 75, 100, 150, 200, 300, 400, 500, 750, 1000, or the like.

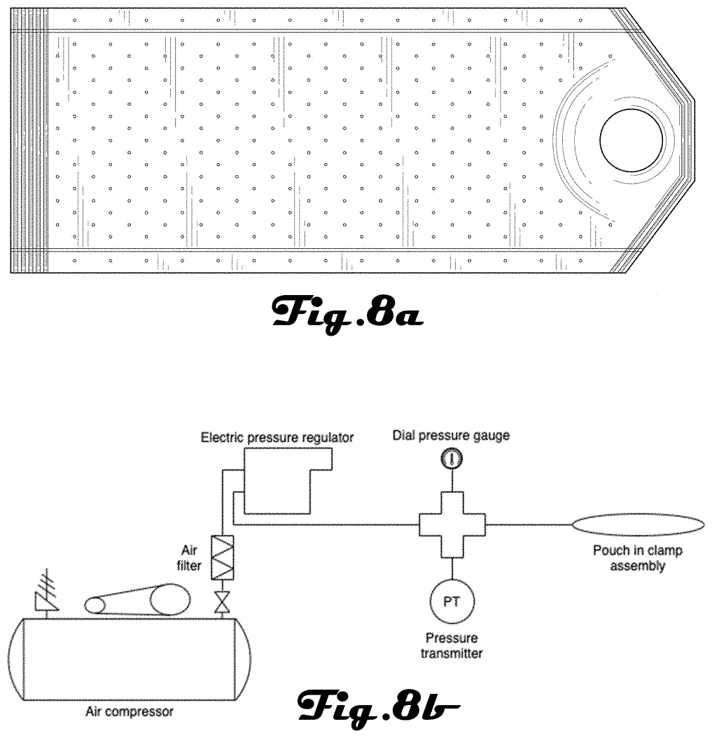

The heat exchanger array 200 further comprises fluid conduits 335A, 335B, which extend through and operably connect the heat exchanger units 100 via coupled ports 120 on opposing adjacent sides of the heat exchanger units 100 (see e.g., FIGS. 8a and 8b). For example, a flowing fluid can be received at a first fluid conduit 335A, flow into the chambers 110 of the heat exchanger units 100 via respective first ends 111, and then flow out second ends 112 into a second fluid conduit 335B. The heat exchanger units 100 can leave open an air path between them via passages 330, and are connected together at the first and second fluid conduits 335A, 335B to provide a liquid flow path.

As discussed in more detail herein, in some embodiments sheets 115 of a given heat exchanger unit 100 can be welded to adjacent sheets 115 of adjacent heat exchanger units 100 about aligned ports 120 of the heat exchanger units 100. However, where a plurality of heat exchanger units 100 having the same configuration are stacked to form a heat exchanger array 200, heat exchanger units 100 at the top and bottom of the stack may be open and not have a second adjacent heat exchanger unit 100 to couple with an outward-facing port 120. In such examples, a patch, end-port coupler, end port 306A, 306B, or the like, can be welded over the open outward-facing port(s) 120 to close the open outward-facing port(s) 120 or to attach fluid tubes to the heat exchanger array 200.

A variety of welding processes can be used to make each heat exchanger unit 100 within such a heat exchanger array 200, but connecting the heat exchangers 100 to each other to generate a heat exchanger array 200 with closed pathways for fluid communication can present a difficult problem in some embodiments. In one example process, a single layer of one sheet 115 of a first heat exchanger unit 100 is welded to the adjacent layer on the next sheet 115 of an adjacent second heat exchanger unit 100, but the two sheets 115 of the same heat exchanger unit 100 are not welded together since that would close off the liquid flow path.

In some embodiments, a spacer or other suitable element can be inserted between sheets 115 of the same heat exchanger unit 100 to prevent a weld internal in the first heat exchanger unit 100, while allowing welds to adjacent sheets 115 of a second and third heat exchanger unit 100 on opposing sides of the first heat exchanger unit 100. Spacers or other suitable elements can be inserted between sheets 115 of the second and third heat exchanger units 100, and so on, to allow for coupling of adjacent heat exchanger units 100 while preventing internal coupling of heat exchanger unit 100, which would close off a fluid path.

In embodiments using a spacer, or the like, heat used to generate a weld may then have to conduct through three layers of material (two layers of polymer sheets 115 plus the spacer) to generate the desired weld, which may require higher temperatures and potentially melting or deforming the top layer of material and affecting the quality of the next weld connection. In addition, in some examples, this would weld only one sheet 115 onto a stack at a time, which could limit the speed of the assembly process.

This issue can be solved, in some embodiments, by generating the heat for the sealing from inside the heat exchanger unit 100 while using this sealing element as a spacer to maintain the internal flow channel. This can be accomplished using various methods. In one example, a conductive element 550 comprising a strip of a patterned conductive material laminated between two layers of a nonstick material can be inserted between two sheets of plastic film before the heat exchanger element is sealed together.

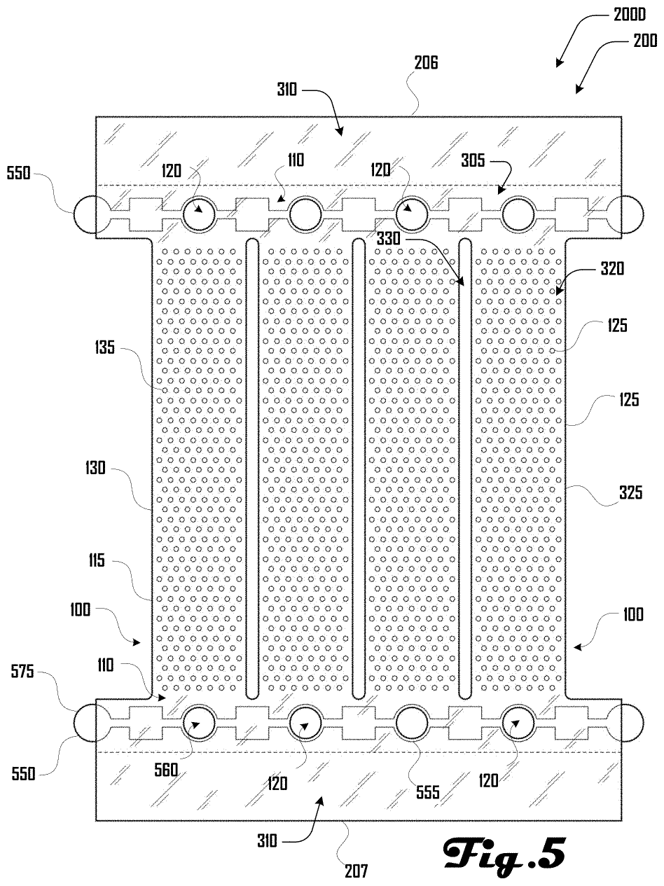

An example of the shape of a conductive element 550 is shown in FIG. 5, which includes an elongated strip having a plurality of thin circular elements 555 that define a central hole 560 and a plurality of rectangular larger elements 565. The thin circular elements 555 and the rectangular larger elements 565 can be coupled by connectors 570 with the thin circular elements 555 and the rectangular larger elements 565 alternatingly present along the length of the conductive element between a pair of ends 575.

The conductive element 550 material can be wide where no weld is desired and can be thin where a weld is desired. For example, the width of the thin circular elements 555 can be sized such that when a selected electric current is applied to the conductive element 550, heat is generated at the conductive element 550 of a sufficient temperature to generate a weld of polymer sheets 115. The width of the rectangular larger elements 565 and/or connectors 570 can be sized such that when the selected electric current is applied to the conductive element 550, any heat generated at the elements 565, 570 is not of a sufficient temperature to generate a weld of polymer sheets 115 and/or not of a sufficient temperature to undesirably harm the polymer sheets 115 by melting, or the like.

For example, to seal a plurality of heat exchanger units 100 together in some embodiments, the plurality of heat exchanger units 100 are folded and/or stacked onto each other and aligned. FIGS. 5 and 6 illustrate an embodiment 200D of a heat exchanger array 200 comprising a pair of sheets 115 configured and coupled to define a plurality of heat exchanger units 100 that are coupled together.

The heat exchanger array 200D is shown as further comprising a first and second conductive element 550 disposed between the sheets 115 at the first and second ends 206, 207 of the heat exchanger array 200, with the holes 560 of the circular elements 555 being aligned with the ports 120 and the circular elements proximate to the edges of the sheets 115 that define the ports 120. Ends 575 of the conductive element 550 are shown extending from the sides of the heat exchanger array 200D.

While one specific embodiment of a heat exchanger array 200D and conductive element 550 is shown in FIG. 5 it should be clear that other embodiments are within the scope and spirit of this invention and that this example should not be construed as being limiting. For example, while the heat exchanger units 100 in this embodiment 200 are shown as being connected, in further embodiments, the heat exchanger units 100 can be separate elements that are stacked and coupled about the ports 120 to generate connections between respective heat exchanger units 100. Additionally, various other suitable methods can be used to couple heat exchanger units 100 about the ports 120.

For example, another embodiment can include using patches of a similar design inserted between pairs of sheets 115 of respective heat exchanger units 100 such as annular patches of conductive material that would cover the area to be sealed (e.g., about the ports 120). Such a patch can be constructed out of aluminum foil between two layers of a high-temperature non-stick material such as Teflon tape, or the like.

In various embodiments, welding between sheets 115 can be accomplished without heat, by depositing a solvent that solvates a polymer of the sheets 115 onto the region to be welded. The solvent can be deposited in either liquid, vapor form, or the like. Such a solvent can be deposited on the region where adhesive would otherwise be used. Examples of solvents can include cyclohexane, methylene dichloride, ethylene dichloride, acetone, n-hexanol, 1,2-dichloroethane, methyl benzene, and the like.

As discussed herein, some embodiments can include the insertion of a separate element into the inside of the heat exchanger units 100 of a heat exchanger array 200, whether that element be a porous spacer, a metal ring for induction welding, or the like. Such an insert element can be inserted into the heat exchanger units 100 by various suitable methods such as: (1) including the element between the sheets 115 of the heat exchanger units 100 before the sheets 115 are welded together, (2) bending the insert element so that it fits through a hole of one or more heat exchanger elements 100 (e.g., one or more ports 120), and (3) leaving an end of a heat exchanger unit 100 un-welded and inserting the insert element through the open end, before later welding closed the open end of the heat exchanger element.

Various embodiments can include one or more of: ultrasonic welding through barrier layer; laser transmission welding; using coextruded film with polar outer layer or lower temp melting point outer layer for thermal welding, or just using laminated layer of lower melt temp material on outside of the manifold region; using drilled/injection molded spacers with foil laminated onto the faces; using drilled/injection molded spacers with gaskets; using drill/injection molded spacers that are made of a material with greater heat resistance than the membranes that are to be welded; inserting heated rod and using conductive or radiative heat transfer, shielding using either spacers or films; and/or using a coex/laminated patch.

Welds can be generated in various suitable ways with various suitable materials. For example, welds can include welds between polymer sheets 115. A weld in accordance with various embodiments can be the joining together of two or more separate elements by heating portions of the two or more separate elements to the point of melting such that the melted portions merge while melted and then cool to generate a unitary solid structure that integrally joins the two or more separate elements.

In contrast, preventing a weld, without welding or a non-weld can include heating of one or more separate elements, and such one or more elements may be heated to the point of melting; however, the elements do not or are prevented from merging while melted and do not generate a unitary solid structure that integrally joins the two or more separate elements. In other words, the one or more separate elements remain separate, even if such one or more separate elements are exposed to heat, melt, and/or cool and solidify from a melted state.

In some examples, spacers and/or a nonstick material can be used to prevent welds. For example, such nonstick materials can interface with first and second areas where one or both of the first and second areas are melted to form one or more welds with one or more additional areas (e.g., a third and fourth areas). However, the nonstick materials can prevent coupling or welding of the first and second areas to each other including a coupling via the nonstick material or spacer, while the weld to the one or more additional areas is generated.

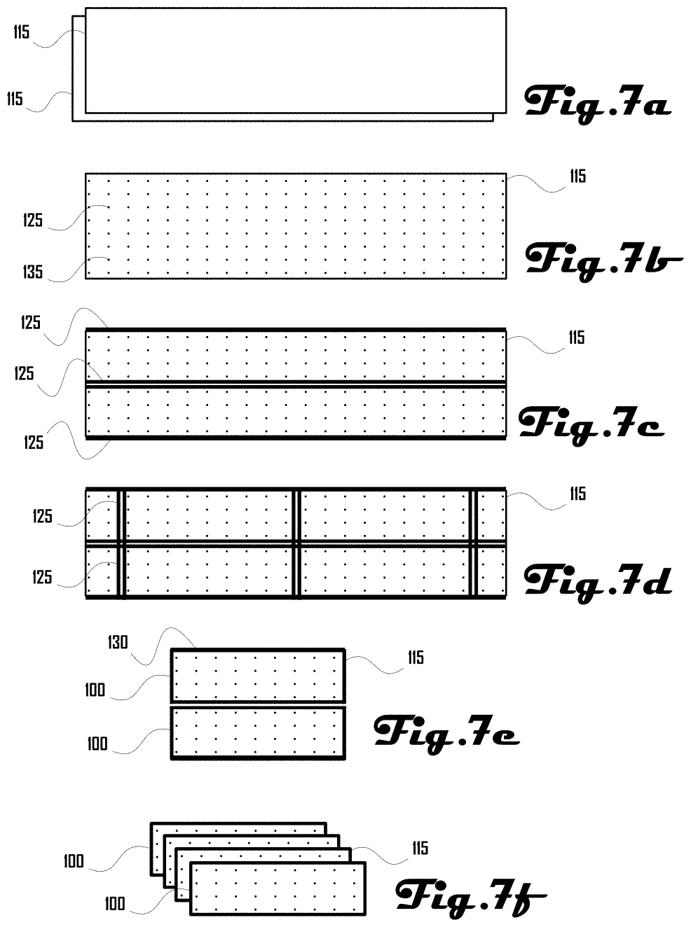

Turning to FIGS. 7a-7f a method of manufacturing a plurality of heat exchanger units 100 is illustrated. FIG. 7a illustrates starting with a pair of sheets 115, which as described herein, can be various embodiments of mono-layer or multi-layer polymer sheets 115. The pair of sheets 115 can be stacked together and welded (e.g., ultrasonic, thermal, or the like) as shown in FIG. 7b to generate a plurality of welded seams 125 which can define internal couplings 135 between the sheets 115. These internal couplings can be various shapes and sizes including circular, rectangular, and the like.

In some embodiments, in can be desirable to dot-weld the entire surface of the sheets 115 and/or minimize the un-welded area to maximize area utilization. Burst pressure of heat exchanger units 100 with a constrained un-welded area can be higher in some example than that of unconstrained un-welded area heat exchanger units 100. In some examples, it can be desirable to configure the space between such dot welds relative to the structure and thickness of the heat exchanger units 100 being generated. This can be to ensure that there is enough maximum deflection on the airside(s) of the heat exchanger units 100 to improve the air-side heat transfer coefficient.

A plurality of elongated linear welds can be further generated in the pair of coupled sheets 115, to create welded seams 125 between the sheets 115, which can ultimately define peripheral edges 130 of one or more heat exchanger units 100. As shown in the examples of FIGS. 7c and 7d such elongated linear welds can be perpendicular (e.g., vertical and horizontal), including one or more sets of elongated linear welds that are grouped close together, which can facilitate cutting the coupled sheets 115 into separate individual heat exchanger units 100 as shown in FIG. 7e. Separate heat exchange unit 100 can receive various additional processing such as generating one or more ports 120, and the like, and the heat exchanger units 100 can be stacked together as shown in FIG. 7f to form a heat exchanger array 200 as discussed herein. In various embodiments, the manufacturing method illustrated in FIGS. 7a-f can be desirable for eliminating or reducing the amount of scrap material generated during manufacturing.

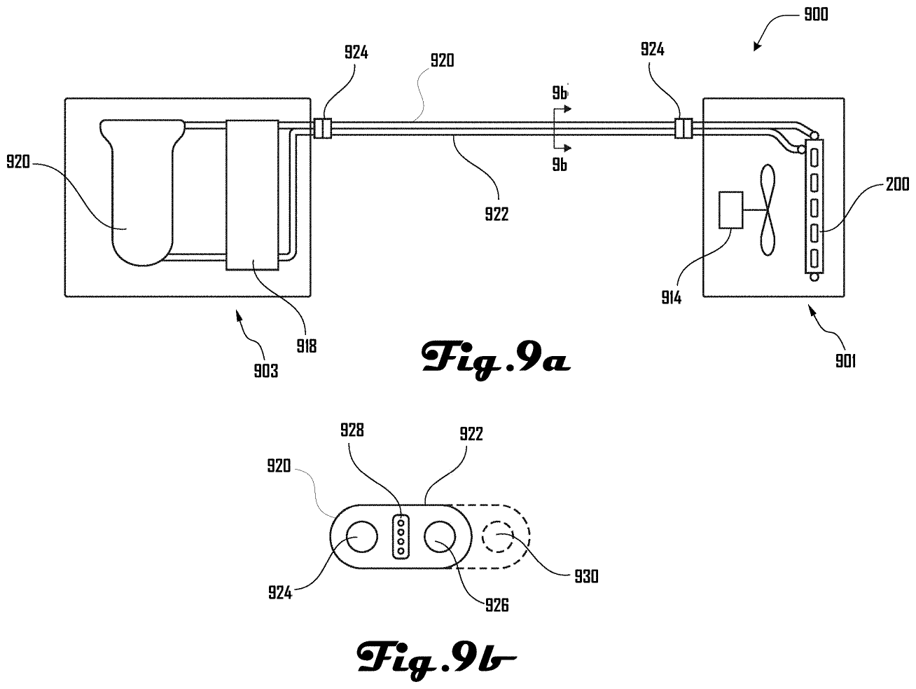

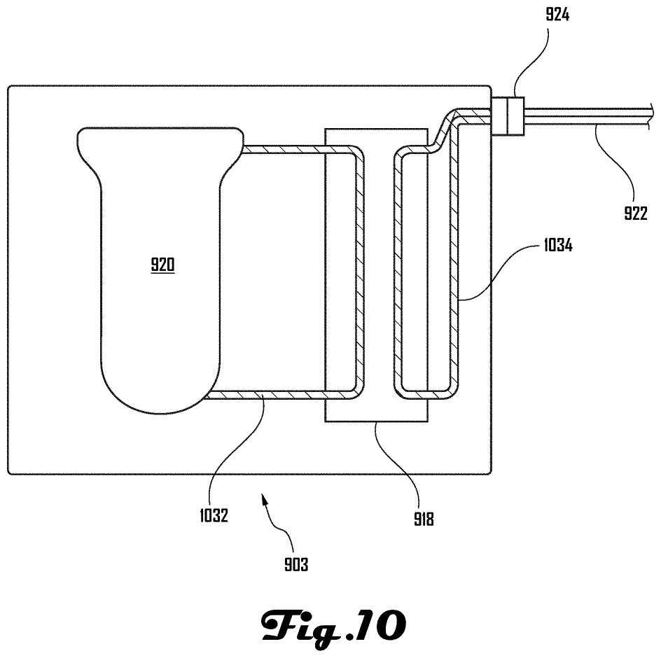

Turning to FIGS. 9a, 9b, 10 and 11, an example embodiment of a modular climate control unit 900 is illustrated. As shown in FIG. 10, the modular climate control unit 900 can include at least one user-positionable interior unit 901 wherein the interior unit 901 includes a fluid to air heat exchanger array 200 and a fan 914 to circulate air across the fluid to air heat exchanger array 200, an exterior unit 903 including a fluid to fluid heat exchanger 918 and a system 920 for supplying a working fluid having a controlled temperature to a first side of the fluid to fluid heat exchanger 918 and a circulation hose 922 defining one or more operable connections 910 between a fluid side of the fluid to air heat exchanger array 200 and a second side of the fluid to fluid heat exchanger 918, wherein the circulation hose 922 allows a circulating fluid to transport heat between the at least one interior unit 901 and the exterior unit 903. As will be discussed in more detail below, the circulating fluid can be a non-toxic, user serviceable fluid and the circulation hose 922 can be coupled to at least one interior unit 901 and the exterior unit 903 in a releasable manner.

Turning to the example exterior unit 903 in more detail, the exterior unit 903 can comprise a system 920 for controlling the temperature of a working fluid. The system 920 for controlling the temperature may be a heat pump, compressor or the like. In the case of a heat pump, the system 920 may provide, add or remove heat to/from the working fluid. In contrast, if only a compressor is provided, the system 920 may remove heat from the working fluid. Further, the exterior unit 903 can include a fluid to fluid heat exchanger 918 that can allow the exchange of heat between the working fluid on one side of the heat exchanger 918 and the circulating fluid on the other side of the heat exchanger 918. A fan and various other components such as controls may also be included in the exterior unit 903 in some embodiments.

The interior unit 901 can comprise a fan 914 and a fluid to air heat exchanger 200. In some examples, the interior unit 901 includes a fluid pump and a circulating fluid storage tank that will operate as described below in more detail.

The circulation hose 922 can comprise a detachable hose that extends between the interior 901 and exterior units 903. For example, as can be seen at FIG. 9b, the circulation hose 922 can include three lumens therein that act as a fluid supply 924, a fluid return 926 and wiring 928 for power and/or control signals between the interior 901 and exterior units 903. The circulation hose 922 may further optionally include a fourth lumen 930 to serve as a conduit to convey condensate back to the exterior unit 903 from the interior unit 901 preventing the need for a condensate drain therein.

It can be appreciated by one skilled in the art that within the scope of the present disclosure we have described an outdoor unit 903, however, it should be appreciated that the outdoor unit 903 may be positioned indoors as well at a location wherein the user is not concerned about the potential for heat gain. Further, it is anticipated within the scope of the present disclosure that the air-cooled condenser may be a fluid cooled condenser and more particularly a condenser that is cooled using ground source water.

As illustrated in FIG. 10, the outdoor unit 903 can operate using a heat pump/air conditioning cycle to reduce the temperature of working fluid 1032 or coolant, which in turn extracts heat from a circulating fluid 1034 via the fluid to fluid heat exchanger 918. The cooled circulating fluid 1034 is then circulated, via the circulation hose 922, between the exterior and interior units 903, 901. As was illustrated in FIG. 9a, the circulating fluid 1034 may be directed through the fluid to air heat exchanger 200 in the interior unit 903 to cool the air directly.

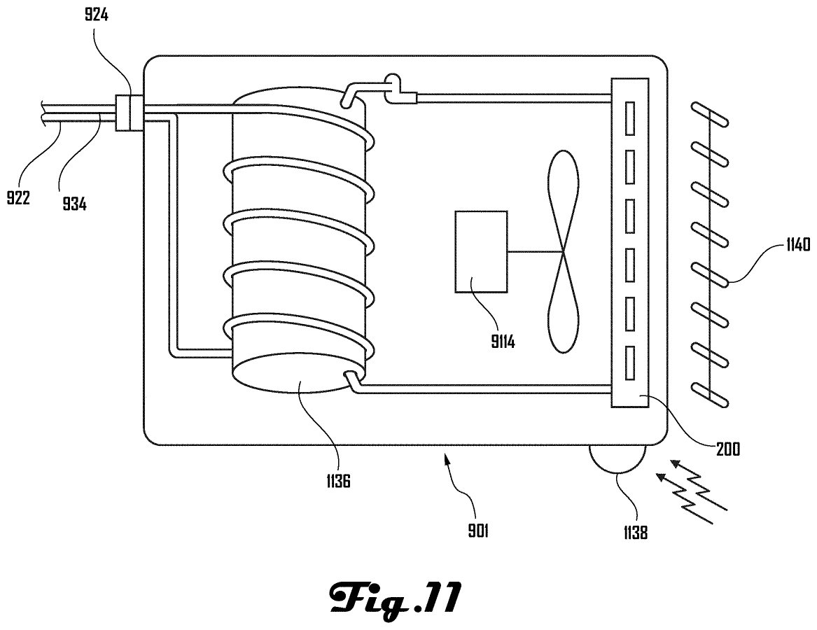

Further, as can be seen in FIG. 11, the circulating fluid 1034 may be directed to reduce the overall temperature of a fluid storage tank 1136 within the interior unit 901. In this embodiment, when cooling is needed in the indoor space, cold fluid from the cold fluid storage tank 1136 is circulated through the fluid to air heat exchanger 200 where the fan 914 circulates room air across the heat exchanger 200 producing a cooling effect. One skilled in the art should appreciate that while the fluid storage tank 1136 is shown in the interior unit 901 it could also be positioned within the exterior unit 903 or independently at an intermediate position along the circulation hose 922.

The example arrangement of FIG. 11 can allow a room cooling function and a fluid cooling function to be decoupled from one another in a temporal sense in that the control system may only operate the outdoor unit 903 when the temperature of the circulating fluid rises above a certain set point. Similarly, the indoor unit 901 can independently increase or decrease fan speed and fluid circulation rate in order to provide a great deal of control over the cooling effect as compared to the prior art on or off cooling systems. This decoupling of the indoor cooling loop and the outdoor cooling loop can further allow the outdoor unit 903 to cool the fluid when it is most efficient to do so. For example, the outdoor unit 903 may cool the fluid stored in the interior insulated cold fluid storage tank at night for cooling use during the day when the outdoor ambient temperatures increase.

In various embodiments, the circulating fluid can be a non-toxic, low freezing point coolant such as salt brine of water mixed with polyethylene glycol. This can be contrasted with some systems that circulate a refrigerant such as Freon or R-10 between the indoor and outdoor units 901, 903. The arrangement of various embodiments allows a user to selectively connect an indoor unit 901 with an outdoor unit 903 using a modular hose arrangement thereby eliminating a great deal of complexity and cost. Further, this arrangement can allow for freedom in placing the indoor unit 901 as needed for maximum cooling effect and occupant comfort. The circulation hose(s) 922 can be attached to the indoor and outdoor units 901, 903 using a quick release style coupler 942. Such quick release couplers 942 can include valving therein that prevents leakage of circulating fluid 1034 when the circulation hose(s) 922 are disconnected.

To further enhance the modularity of the air conditioning unit 900, the indoor and/or outdoor units 901, 903 can be arranged such that they include multiple hose connection points so that multiple indoor units 901 can be connected to a single outdoor unit 903. Such connections may be parallel or made directly from each of the indoor units 901 to the outdoor unit 903. Alternately the indoor units 901 may be connected in series or in a daisy chain arrangement with the outdoor unit 903. Turning back to FIG. 11, the indoor unit 901 may include such functionality as heat sensors 1138 and servo directed louvers 1140 to direct cooling airflow to hotspots in a room (e.g., room occupants). Further, the indoor unit 901 may be configured to collect condensate and deposit the condensate back into the loop of circulating fluid 1034. The outdoor unit 903 can then be configured to eject some fluid from the loop of circulating fluid 1034 should the fluid capacity of the loop of circulating fluid 1034 be exceeded by the addition of condensate.

It should be further appreciated by one skilled in the art that the arrangement of the various examples could operate equally well as a heating system. In operation, the change that could be made is that the outdoor unit 903 would be run as a heat pump rather than as an air conditioner. In this manner, rather than cooling the circulating fluid, the outdoor unit 903 would heat the circulating fluid. Optionally, the indoor unit(s) 901 may instead include a supplemental heating arrangement such as an electrical heating coil.

It can therefore be seen that the present disclosure illustrates examples of a modular air conditioner unit 900 that can operate on the basic principle of a split system yet allows user serviceability and modular components such that the system is flexible. Further, various embodiments provide a modular air conditioning unit 900 that includes at least one indoor cooling unit 901 that has an integrated cold storage therein such that the temperature of the cold storage is maintained by circulating a coolant fluid through user serviceable hose connections with an outdoor heat dissipation unit.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, elements that are specifically shown in example embodiments should be construed to cover embodiments that comprise, consist essentially of, or consist of such elements, or such elements can be explicitly absent from further embodiments. Accordingly, the recitation of an element being present in one example should be construed to support some embodiments where such an element is explicitly absent.

### Example 1: Burst Tests on Multilayer Sheets

Ultrasonically welded heat exchanger unit samples composed of two different structures of aluminum foil multilayer sheets were tested for strength. The rotary ultrasonic welding was used to generate the heat exchanger unit samples from pairs of sheets of the two Sheet Structures. The two Sheet Structures are classified as:

Sheet Structure 1 composed of a 70 μm cast polypropylene sealant layer, a 9 μm aluminum foil layer and a 12 μm PET exterior layer; and

Sheet Structure 2 composed of an 80 μm cast polypropylene sealant layer, a 9 μm aluminum layer, a 15 μm biaxially oriented nylon layer and a 12 μm PET exterior layer.

Different welding settings were used to produce the heat exchanger units from the two different Sheet Structures. The three main parameters that were investigated for producing the pouches were: vibration amplitude, anvil force and production speed.

Heat exchanger unit burst test samples were made out of pouches that were ˜20 cm long and 6.5 cm wide. The two ends of the pouches were sealed together using a H-1069 6″ Crimper Hand Sealer with a 15 mm (0.6″) wide heating element. The geometry of the burst test samples is illustrated in FIG. 8a. A spacer with flow holes was inserted at the top of each heat exchanger unit burst test sample before the tops of the test sample were heat sealed with the crimper. The burst test setup was composed of an air compressor connected to a 0-60 psi pressure regulator, a 0-60 psi electronic pressure transmitter, a dial pressure gauge and an air tight pouch clamp. The basic schematic of the setup and the pouch clamp are shown in FIG. 8b. Each heat exchanger unit sample was burst-tested by incrementally increasing the pressure within the pouch from 5 psi to 60 psi with increments of 0.73 psi, while dwelling on each increment for 5 seconds for the pressure to stabilize. The burst pressure for the different test samples was determined to be the peak pressure recorded during pressurization before the pouches started leaking and pressure decreased by more than 5 psi. The results of the burst tests were as follows.

### Structure 1 Burst Test Results:

| Sample | Processing | Vibration | Weld | Average burst |
|---|---|---|---|---|
| Number | speed (m/min) | amplitude (%) | force (N) | pressure (PSI) |
| 1 | 5 | 70 | 596 | 36.16 ± 0.27 |
| 2 | 5 | 70 | 650 | 30.65 ± 1.76 |
| 3 | 5 | 100 | 500 | 36.3 ± 4.23 |
| 4 | 5 | 100 | 650 | 35.62 ± 2.65 |
| 5 | 5 | 70 | 500 | 25.62 ± 1.02 |
| 6 | 15 | 70 | 500 | 10.93 |

### Structure 2 Burst Test Results:

| Sample | Processing | Vibration | Weld | Average burst |
|---|---|---|---|---|
| Number | speed (m/min) | amplitude (%) | force (N) | pressure (PSI) |
| 1 | 5 | 70 | 500 | 37.29 ± 1.18 |
| 2 | 5 | 70 | 601 | 33.06 ± 2.43 |
| 3 | 5 | 70 | 650 | 28.84 ± 0.8 |
| 4 | 5 | 100 | 500 | 52.25 ± 2.97 |
| 5 | 5 | 100 | 650 | 44.01 ± 2.35 |
| 6 | 10 | 85 | 650 | 27.54 |

### Example 2: Permeability Testing of Monolayer and Multilayer Sheets

Permeability tests of various monolayer and multilayer polymer sheets were conducted to determine if such sheets would be suitable for use in certain embodiments of heat exchanger systems, including whether such sheets would have low enough permeability to satisfy a water vapor transmission rate (WVTR) of less than 0.00048 g/(m²h) or less than 0.01 g/(m² day).

Pouches were made from three classes of sheet structures: four were made from monolayer polypropylene, four were made from aluminum laminate multilayer films and two made from metallized polyester. One of the monolayer films was a cast polypropylene homopolymer and the other was a polypropylene copolymer. Two samples of aluminum laminate multilayer films were used, with one having 100 μm wall thickness and the other having 150 μm wall thickness. One sample of metallized polyester film (Mylar) was used having a wall thickness of 50 μm. The pouch materials, thicknesses, and surface areas are shown in Table 1 below. The pouches were partially filled with tap water and sealed on all edges with an IPK-305H impulse sealer with a 5 mm heating element except for the 150 μm film pouches. The power on the impulse sealer was not sufficient to seal the 150 μm film pouches, therefore a H-1069 6″ Crimper Hand Sealer with a 0.6″ (15.24 mm) element width was used instead.

Two samples of different shapes were made for each film material, A-samples were designed to have about twice the surface area of B-samples while having roughly the same welded perimeter as shown in Table 2 below. This was to verify that mass loss was proportional to area as should be the case for permeation, and to ensure that if there were any losses through the welded joints, it would be the same for each pouch sample.

TABLE 1

| | | Film | |
|---|---|---|---|
| Pouch | | thickness | Surface |
| label | Source material | (μm) | area (m²) |
| 1A | Profol Cast Polypropylene | 127 | 0.02273376 |
| 1B | Profol Cast Polypropylene | 127 | 0.0105456 |
| 2A | Torey Polypropylene copolymer | 127 | 0.0275992614 |
| 2B | Torey Polypropylene copolymer | 127 | 0.01348602 |
| 3A | MIRE Beverage pouch | 100 | 0.0099053772 |
| 3B | MRE Beverage pouch | 100 | 0.0056688 |
| 4A | MIRE Crackers pouch | 150 | 0.0169799028 |
| 4B | MIRE Crackers pouch | 150 | 0.007965931 |
| 5A | Mylar party balloon | 40 | 0.0234669568 |
| 5B | Mylar party balloon | 40 | 0.01316766 |

TABLE 2

| Pouch number | Area ratios (A/B) | Welded length ratios (A/B) |
|---|---|---|
| 1 | 2.16 | 0.96 |
| 2 | 2.05 | 0.95 |
| 3 | 1.75 | 1.24 |
| 4 | 2.13 | 1.32 |
| 5 | 1.78 | 0.90 |

The sample pouches were placed in a heated box at 46.5° C. filled with desiccant. At regular intervals in time the pouches were removed from the heated box and their mass was measured to determine how much water had permeated through the film. A high precision scale (Ohaus SPX223, accuracy of ±0.003 g) was used to weigh the polymer pouches and record the mass of water lost over a period of about 500 hours.

Testing indicated that the pouches made of monolayer sheets did not satisfy a WVTR of less than 0.00048 g/(m²h) or less than 0.01 g/(m² day) whereas the multilayer pouches demonstrated a WVTR of less than 0.00048 g/(m 2h) or less than 0.01 g/(m² day).

For example, the monolayer sheets had an average WVTR of 7.4 g/(m² day). Applying this WVTR to the entire surface area of an example heat exchanger system, and correcting for the expected maximum temperature and minimum humidity in a home, it was estimated that up to 130 kg of water could permeate through a heat exchanger over a 20-year lifetime of the example heat exchanger product. This was estimated to be about three orders of magnitude higher than would be acceptable for the expected reservoir volume in the example heat exchanger system. However, multilayer sheets comprising aluminum would satisfy a WVTR of less than 0.00048 g/(m² day) or less than 0.01 g/(m² day), which would provide a suitable rate of fluid loss that would be acceptable for the expected reservoir volume in the example heat exchanger system and the goal that the heat transfer fluid should not need to be refilled.

What is claimed is:

1. An air thermal conditioning system for at least one of heating air and cooling air, the air thermal conditioning system comprising:
a cross-flow heat exchanger array that includes:
a housing;
a plurality of at least 25 stacked planar membrane heat exchanger units disposed in parallel and held in tension by the housing via respective opposing top and bottom ends of the respective planar membrane heat exchanger units, the planar membrane heat exchanger units stacked in parallel with a space separating each of the planar membrane heat exchanger units, with each of the planar membrane heat exchanger units comprising:
at least one fluid chamber defined by first and second planar multilayer polymer sheets and a welded seam, with the at least one fluid chamber extending between the opposing top and bottom ends and opening to a first and second port defined by the first and second planar multilayer polymer sheets at the top and bottom ends respectively; and
the first and second planar multilayer polymer sheets having a thickness between 80 and 110 μm, and each comprising:
an inner layer directly defining and facing the at least one fluid chamber, the inner layer having a thickness between 50 and 90 μm and consisting essentially of one of: polypropylene, cast un-oriented polypropylene (CPP), polyethylene, polyethylene terephthalate (PET), a fluoropolymer, a polyimide, or a polyamide;
a middle layer consisting essentially of a material with a lower permeability and a higher melting point than the inner layer, the middle layer having a thickness between 8 and 10 μm and consisting of aluminum, silicon oxide, or aluminum oxide; and
an outer layer that defines external opposing faces of the planar membrane heat exchanger unit that has a thickness between 10 and 20 μm and consists essentially of one of biaxially-oriented polyethylene terephthalate (BOPET) or biaxially oriented polypropylene, the middle layer disposed between the inner layer and outer layer and coupled together to define a unitary planar multilayer polymer sheet without cavities, gaps or un-joined portions between layers; and
a first and second fluid conduit respectively disposed at and communicating with the first and second ports of the planar membrane heat exchanger units, the first and second fluid conduits fluidically coupling the plurality of planar membrane heat exchanger units and configured to generate a fluid flow within the fluid chambers of the plurality of planar membrane heat exchanger units, the fluid flow:
flowing into the first fluid conduit,
flowing between the top and bottom ends within the respective chambers, and
flowing out the second fluid conduit, with fluid flowing in and out of the first and second fluid conduits respectively on the same side of the cross-flow heat exchanger array.

2. The air thermal conditioning system of claim 1, wherein the middle layer, inner layer and outer layer are coupled together via one or more of adhesive, sealant, welding, thermoplastic melt or lamination to form the unitary planar multilayer polymer sheet without cavities, gaps or un-joined portions between the middle layer, inner layer and outer layer.

3. The air thermal conditioning system of claim 1, wherein the middle layer consists essentially of aluminum foil or metallized aluminum.

4. The air thermal conditioning system of claim 1, wherein each of the first and second planar multilayer polymer sheets consists of:
the inner layer,
the middle layer,
the outer layer, and
a fourth layer consisting essentially of biaxially oriented nylon (BON) and having a thickness of less than or equal to 20 μm.

5. The air thermal conditioning system of claim 1, wherein the first and second planar multilayer polymer sheets are configured to be coupled together to form a heat exchanger unit by exposing adjoining inner layers to sufficient heat to melt and join the adjoining inner layers, but at a temperature and for a time that does not melt the middle layers with the higher melting point than the inner layers.

6. An air thermal conditioning system for at least one of heating air and cooling air, the air thermal conditioning system comprising:
a heat exchanger array that includes:
a plurality of planar membrane heat exchanger units disposed in parallel with a space separating each of the planar membrane heat exchanger units, with each of the planar membrane heat exchanger units comprising:
at least one fluid chamber defined by first and second planar multilayer sheets; and
the first and second planar multilayer sheets each comprising:
an inner layer directly defining and facing the at least one fluid chamber;
a middle layer; and
an outer layer that defines external opposing faces of the planar membrane heat exchanger unit, the middle layer disposed between the inner layer and outer layer and coupled together to define a unitary planar multilayer sheet without cavities, gaps or un-joined portions between layers.

7. The air thermal conditioning system of claim 6, wherein the first and second planar multilayer sheets each have a thickness between 80 and 110 μm.

8. The air thermal conditioning system of claim 6, wherein the inner layer has a thickness between 50 and 90 μm.

9. The air thermal conditioning system of claim 6, wherein the inner layer consists essentially of one of:
polypropylene,
cast un-oriented polypropylene (CPP),
polyethylene,
polyethylene terephthalate (PET),
a fluoropolymer,
a polyimide, or
a polyamide.

10. The air thermal conditioning system of claim 6, wherein the middle layer has a thickness between 8 and 10 μm.

11. The air thermal conditioning system of claim 6, wherein the middle layer consists essentially of:
aluminum,
aluminum oxide, or
silicon oxide.

12. The air thermal conditioning system of claim 6, wherein the outer layer has a thickness between 11 and 13 μm.

13. The air thermal conditioning system of claim 6, wherein the outer layer consists essentially of one of:
biaxially-oriented polyethylene terephthalate (BOPET), or
biaxially oriented polypropylene.

14. The air thermal conditioning system of claim 6, each of the first and second planar multilayer sheets consist essentially of:
the inner layer,
the middle layer,
the outer layer, and
a fourth layer consisting essentially of biaxially oriented nylon (BON).

15. An air thermal conditioning system for at least one of heating air and cooling air, the air thermal conditioning system comprising:
one or more heat exchanger units that include:
at least one fluid chamber defined by first and second multilayer sheets, the first and second multilayer sheets each comprising:
an inner layer defining the at least one fluid chamber;
a middle layer; and
an outer layer that defines external opposing faces of the heat exchanger unit, the middle layer disposed between the inner layer and outer layer.

16. The air thermal conditioning system of claim 15, wherein the first and second multilayer sheets have a thickness of less than or equal to 200 μm.

17. The air thermal conditioning system of claim 15, wherein the inner layer comprises at least one of:
polypropylene,
cast un-oriented polypropylene (CPP),
polyethylene,
polyethylene terephthalate (PET),
a fluoropolymer,
a polyimide, or
a polyamide.

18. The air thermal conditioning system of claim 15, wherein the middle layer comprises one or more of:
aluminum,
aluminum oxide, or
silicon oxide.

19. The air thermal conditioning system of claim 15, wherein the outer layer comprises at least of one of:
biaxially-oriented polyethylene terephthalate (BOPET), or
biaxially oriented polypropylene.

20. The air thermal conditioning system of claim 15, each of the first and second multilayer sheets comprise:
the inner layer,
the middle layer,
the outer layer, and
a fourth layer comprising biaxially oriented nylon (BON).
